(19) United States
(12) Patent Application Publication
(10) Pub. No.: US 2006/0075399 A1
(43) Pub. Date: Apr. 6, 2006

(54) System and method for resource usage prediction in the deployment of software applications

(76) Inventors: Choo Woon Loh, Epping (AU); Roy Allan Alingcastre, Narara (AU); Victoria Zaslayski, Matraville (AU)

Correspondence Address: UNISYS CORPORATION, UNISYS WAY, MAILSTOP E8-114, BLUE BELL, PA, 19424-0001, US

(21) Appl. No.: 10/540,947

(22) PCT Filed: Dec. 27, 2002
(86) PCT No.: PCT/US02/41546

§ 371 Date: Jun. 27, 2005

(51) Int. Cl. G06F 9/445

(52) U.S. Cl. 717/174; 717/120; 717/104

(57) ABSTRACT

The invention provides a system and method for predicting a quantity of a resource required for the deployment of a software application on a computing system. The method comprises the steps of providing historical resource utilisation data for deployment of software applications on computing systems, providing a value for a parameter of the computing system relevant to resource utilisation, providing a value for a parameter of the software application relevant to resource utilisation, and utilising the historical resource utilisation data and parameter values to predict the quantity of the resource required for deployment of the software application.

### FIELD OF THE INVENTION

The present invention relates to a system and method for predicting the resources required for the deployment of a software application.

### BACKGROUND OF THE INVENTION

Deploying new software or upgrading existing software to a newer version can often disrupt a computer system, which might need to be shut down and restarted as part of the deployment process and/or might experience degradation of performance. It would be of use to the deployer (the person deploying software applications in a computer system) to know in advance the expected duration of such interruptions and system performance degradation. Deployment tools (typical installation programs) do not provide sufficient information to the deployer to make an informed decision regarding whether to carry out the deployment or to alter his/her deployment plan before deploying in order to minimize the impact on the users of the system.

### SUMMARY OF THE INVENTION

In a first aspect, the present invention provides a method of predicting a quantity of a resource required for the deployment of a software application on a computing system, comprising the steps of providing historical resource utilisation data for deployment of software applications on computing systems, providing a value for a parameter of the computing system relevant to resource utilisation, providing a value for a parameter of the software application relevant to resource utilisation, and utilising the historical resource utilisation data and parameter values to predict the quantity of the resource required for deployment of the software application.

The present invention essentially utilises the historical data relating to resources required for deployment of software applications to predict a resource required for future deployment of a software application.

Preferably, the historical resource utilisation data includes parameter values of the computing systems and parameter values of the software applications historically deployed. It also preferably includes values of the quantities of resources used in the historical deployment (termed herein statistics).

A parameter will be understood to mean a feature or characteristic of the configuration of the computing system, such as, for example, the amount of Random Access Memory in the computing system, or a feature or characteristic of the software application, such as the size of the software application.

A statistic will be understood to mean a quantity of a specific resource required to perform a task, such as, for example, the time it may take for the software application to be deployed.

Preferably, the historical resource utilisation data includes at least two parameter/statistic pairs for historical deployments.

Preferably, a relationship between the parameter and statistic pairs is derived, wherein the resultant relationship may be utilised to predict a statistic for any parameter value.

Preferably, the relationship between the parameter and statistic pairs is derived by applying a statistical model to the parameter/statistic pairs.

Preferably, when a relationship is predicted between a statistic and n distinct parameters, where n is any integer greater than or equal to two, the method comprises the further step of obtaining mₙ different values for each parameter Pₙ, and further obtaining at least m₁m₂ . . . mₙ values of a statistic for each distinct combination of parameter values, where m₁m₂ . . . mₙ represents the product of values m₁, m₂, . . . mₙ.

Preferably, the relationship between the statistic and the parameter or n parameters is determined by assuming that the relationship between the parameter/statistic pairs takes the form of a linear relationship.

Preferably, the equation of the linear relationship is calculated using co-ordinate geometry.

Preferably, the mathematical model takes the form:

$$S = {S}_{a} + \frac{( {S}_{c} - {S}_{a} )}{( c - a )} ( {P}_{k} - a )$$

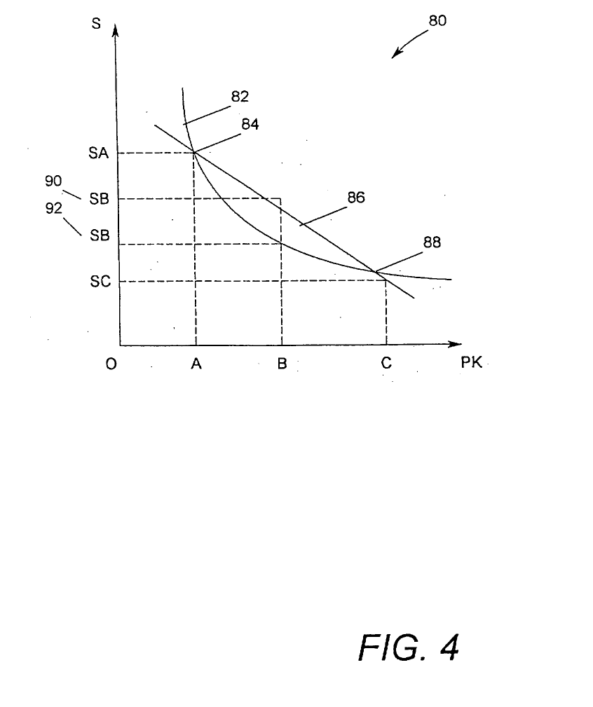

This equation is defined later in connection with FIG. 4.

It will be understood that a computer resource may encompass any hardware or software resource, such as a CPU, volatile or non-volatile memory, the number of processors, the operating system or other software packages, or any other suitable resource.

The present invention preferably provides a number of advantages. Firstly, the invention allows a system administrator or deployer to calculate an estimate of the amount of time needed to deploy an application. In environments running mission critical applications, the amount of “down time” is an important consideration when deciding to upgrade software. A system administrator needs to be able to predict, with reasonable accuracy, the amount of “up time” that will be lost in deploying an application, as it is commonly necessary to make other arrangements (e.g. letting users know in advance when the system will be down, transferring the load to another server, etc.)

Secondly, an embodiment of the present invention allows a system administrator to provide estimates for different computing systems with different resources. Many large corporations run a mixture of different machines, with different resources, different architectures, and different operating systems. When deploying an application across so many different computing systems, a system administrator can preferably plan and more efficiently deploy system resources if an estimate of deployment time can be provided for each different system.

Thirdly, it may be of interest for an application developer to know how much time will be taken for an application to deploy, as this may allow the application developer to incorporate changes into the application to make the deployment process more efficient. For example, if an application developer finds that an application deployment time is appreciably increased when a system has little free memory, the application developer may reconfigure or tweak the deployment process to use less volatile memory.

In a second aspect, the present invention provides a computing system arranged to facilitate the prediction of resources required for the deployment of a software application, comprising a database arranged to provide historical resource utilisation data for deployment of software applications on computing systems, means for providing a value for a parameter of the computing system relevant to resource utilisation, and a value for a parameter of the software application relevant to resource utilisation, and computation means arranged to utilise the historical resource utilisation data and parameter values to predict the quantity of the resource required for deployment of the software application.

In a third aspect, there is provided a computer program arranged, when loaded on a computing system, to control the computing system to implement the method provided in the first aspect of the invention.

In a fourth aspect, there is provided a computer readable medium providing a computer program in accordance a third aspect of the invention.

In a fifth aspect, the present invention provides a method for building a model for use in the prediction of resources required for the deployment of a software application, the method comprising the steps of collecting historical resource utilisation data for deployment of software applications on computing systems, and storing the historical resource usage data.

In a sixth aspect, the present invention provides a model comprising historical resource utilisation data for deployment of software applications on computing systems, the data being stored in a database.

### DETAILED DESCRIPTION OF THE DRAWINGS

Features of the present invention will be presented in the description of an embodiment thereof, by way of example, with reference to the accompanying drawings, in which:

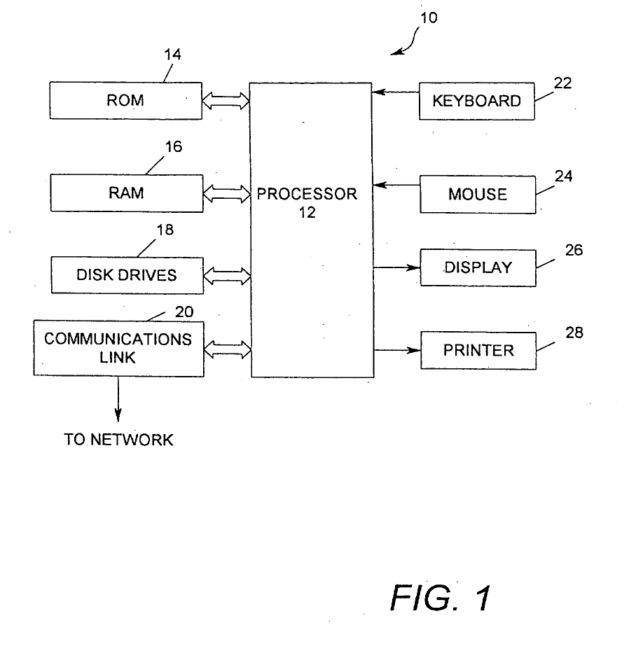

FIG. 1 illustrates a general-purpose computer that may be used to implement the present invention;

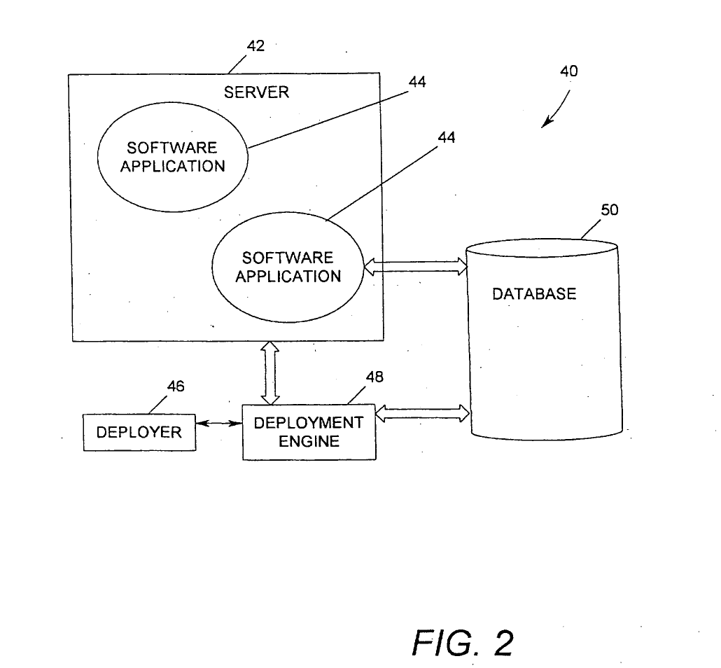

FIG. 2 is a logical diagram of the components of a computer system that may utilize the present invention;

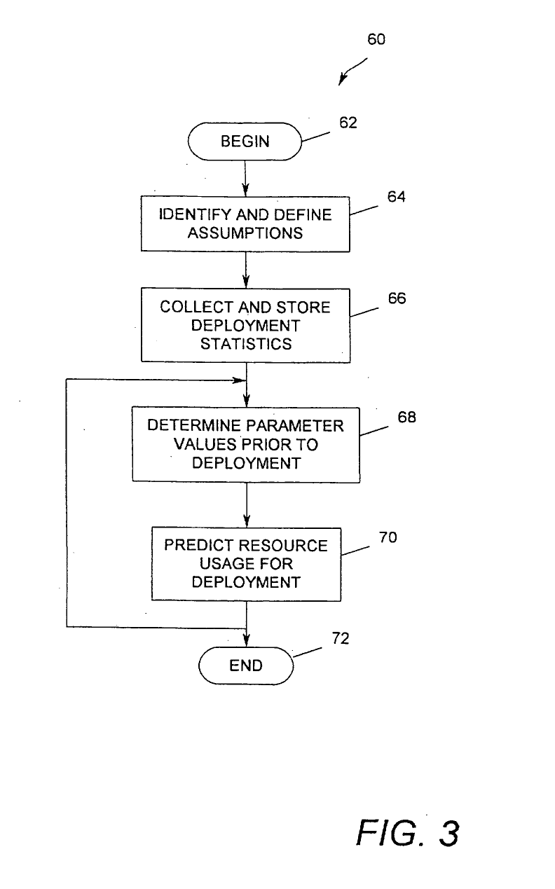

FIG. 3 is a flowchart showing the steps for creating an Impact Analysis Model and predicting the resource usage during deployment;

FIG. 4 is a diagram showing a possible graphical representation of the relationship between an attribute of the computer system and the quantity of a resource used during deployment;

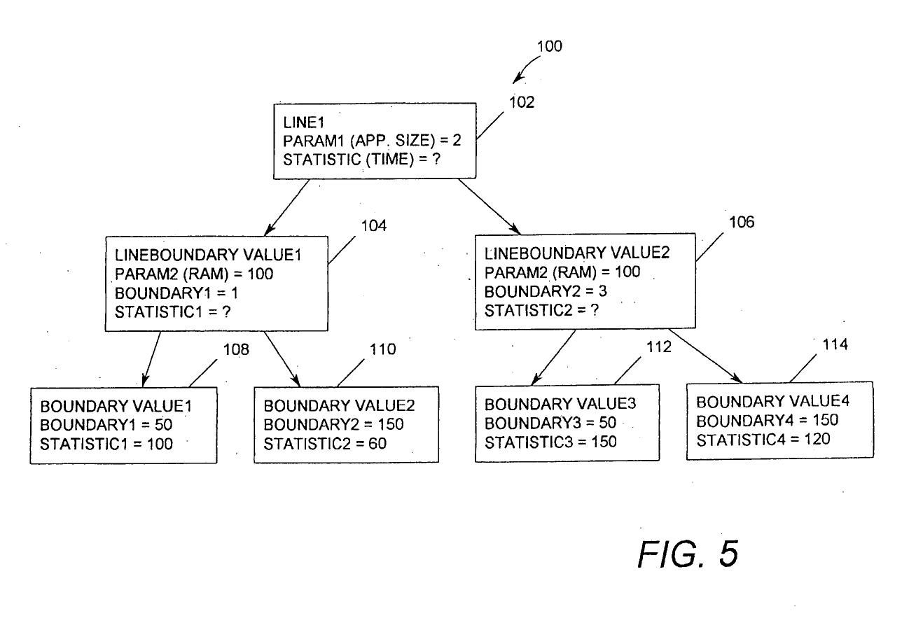

FIG. 5 is a diagram showing an example of a binary tree that can be used to estimate the quantity of a resource used during deployment based on more than one attribute;

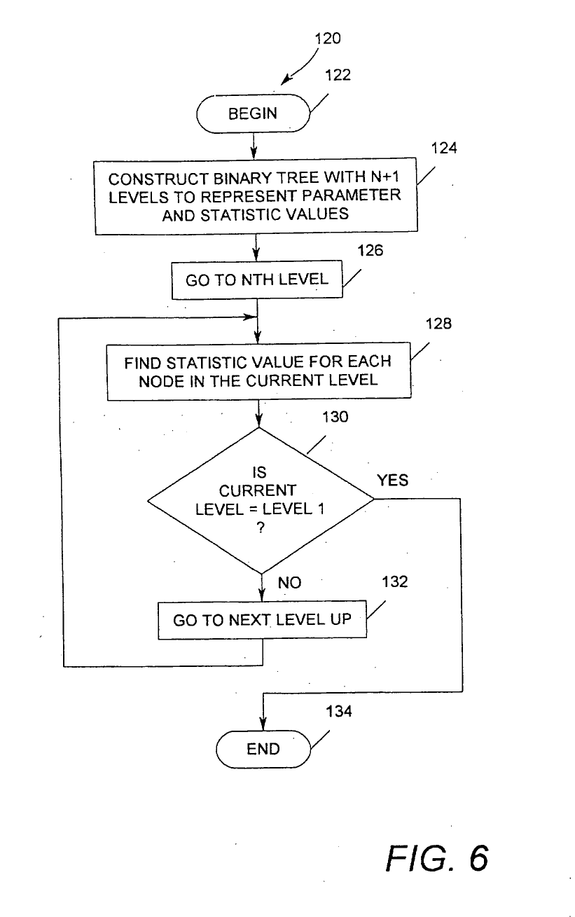

FIG. 6 is a flowchart showing the steps of a method that can be used to estimate the resource quantity used during a deployment based on more than one attribute;

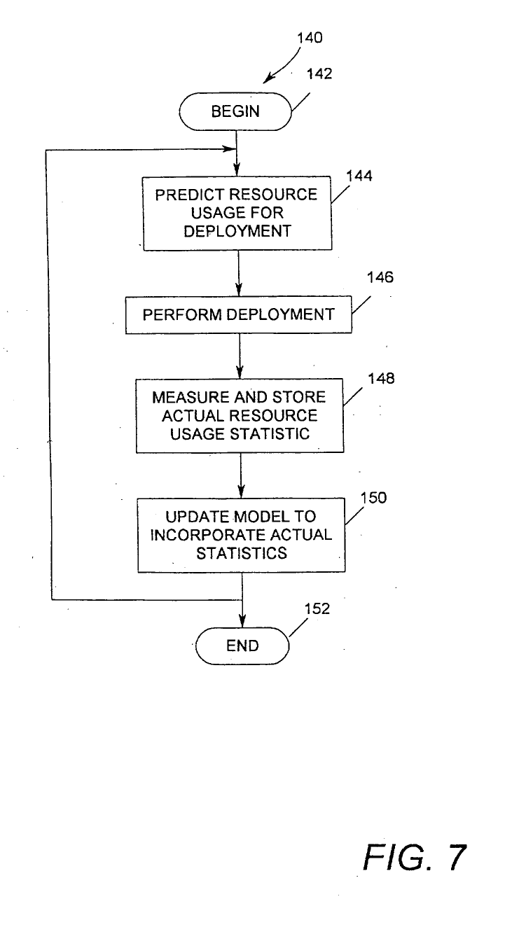

FIG. 7 is a flowchart showing the steps for updating the Impact Analysis Model to improve the accuracy of the prediction of resource usage for a particular computer system.

### DESCRIPTION OF THE PREFERRED EMBODIMENT

At FIG. 1 there is shown a schematic diagram of a computing system 10 suitable for use with an embodiment of the present invention. The computing system 10 may be used to execute applications and/or system services such as deployment services in accordance with an embodiment of the present invention. The computing system 10 preferably comprises a processor 12, read-only memory (ROM) 14, random access memory (RAM) 16, and input/output devices such as disk drives 18, keyboard 22, mouse 24, display 26, printer 28, and communications link 20. The computer includes programs that may be stored in RAM 16, ROM 14, or disk drives 18 and may be executed by the processor 12. The communications link 20 connects to a computer network but could be connected to a telephone line, an antenna, a gateway or any other type of communications link. Disk drives 18 may include any suitable storage media, such as, for example, floppy disk drives, hard disk drives, CD ROM drives or magnetic tape drives. The computing system 10 may use a single disk drive 18 or multiple disk drives. The computing system 10 may use any suitable operating systems, such as Windows™ or Unix™.

It will be understood that the computing system described in the preceding paragraphs is illustrative only, and that deployment services may be executed on any suitable computing system, with any suitable hardware and/or software.

FIG. 2 is a diagram showing a networked computer system 40 comprising one or more computing systems 10 of FIG. 1 networked such that data may be interchanged between the networked computer systems. The networked computer system 40 preferably comprising a server 42 is arranged to run one or more software applications 44. Data used by the software applications 44 is maintained in one or more databases 50 contained in storage media controlled by one or more of the computers 10. In accordance with an embodiment of the present invention, the computer system also contains a deployment engine 48 used to deploy software applications to the server. The deployment engine 48 may or may not be running on the same server as the deployed software applications. An embodiment of the present invention relates to the functionality of the deployment engine 48 to predict the quantities of various resources of the computer system 40 including disk space consumption and time required to perform a deployment of a software application 44 to the server 42, and provide this information to the deployer 46 who will use it to improve decision making regarding deployments.

FIG. 3 is a flowchart detailing the process 60 of constructing an Impact Analysis Model, in accordance with an embodiment of the present invention, in order to implement the functionality of the deployment engine 48 of predicting the amount of various resources required during deployment. The model relies on the following definitions. A parameter is an independent variable that can be quantified. Insofar as it relates to this embodiment of the present invention, a parameter is a feature of the configuration of the computer system 40 and/or the software application 44 to be deployed that the computer system 40 can be instrumented to measure. Examples of parameters include but are not limited to:
the size of the software application to be deployed measured in kilobytes;
the amount of RAM 16 available on the server 42 measured in megabytes;
the number of CPUs in the processor 12 of the computer 10 running the server 42 where the application is to be deployed;
the disk access rate (the rate at which the disk drives 18 read from and write to the storage media) measured in bytes per second; and
the rate of reading from and writing to the database 50 (relevant particularly for update deployments of database access applications) measured in bytes per second.

A statistic is a variable assumed to be dependent on one or more parameters that can be measured. Insofar as it relates to this embodiment of the present invention, a statistic is the quantity of a particular resource required during a deployment. Examples of statistics include but are not limited to:
the time required for deployment of a software application measured in seconds; and
the disk space used during deployment of a software application measured in kilobytes.

It will be understood that the above examples are merely illustrative, as a statistic may be any suitable dependent variable as chosen by a person skilled in the art.

To illustrate the model, the example of predicting the time required for deployment will be used throughout the description of this embodiment of the invention. However, the present invention is not limited to prediction of this resource.

In FIG. 3, after beginning at step 62, the “assumptions” of the model have to be defined at step 64. This involves identifying the parameters that are assumed to influence the value of the statistic to be predicted. In accordance with the example, a possible assumption is that the time required statistic is dependent on only two parameters (for simplicity), the size of the application to be deployed and the amount of RAM 16 available on the server 42. However, more than two parameters may be used in constructing the model without departing from the scope of the invention.

There may be provided a system in accordance with an embodiment of this invention that contains “built in” assumptions. That is, a deployer or user may not have the opportunity to choose which independent variables are to be used in the estimation of the statistic. Alternately, in another embodiment, a deployer or user may choose one or more from a range of independent variables.

After the assumptions of the model are defined at step 64, actual data is collected at step 66, the data forming the historical utilisation data. This data establishes the relationship between the parameters defined in step 64 and the statistic being predicted. Step 66 thus involves performing many deployments. For each deployment the parameters (for the example these are the size of the application to be deployed and the amount of RAM available) of the specific configuration are measured prior to performing the deployment, and the statistic of interest (for the example this is the time taken to deploy) is measured during the deployment. This data is then stored in accordance with step 66 in permanent storage, for instance a relational database, to be retrieved when required for the prediction of the statistic. The volume and scope of data collected in step 66 depends on the method used in step 70 to predict the statistic and the accuracy level required.

In real life, this process could be carried out by a large number of methods. For example, the deployment service could include an internal counter or clock, which counts the time elapsed since the beginning of deployment. Alternately, the deployment could be monitored by internal counters and/or clocks that form part of the computing system or operating system.

After collecting all the necessary data in step 66, the model developed under the present invention can be used to predict the statistic of interest by following steps 68 and 70. These two steps can be performed repeatedly prior to different deployments that require prediction of a particular statistic without having to repeat steps 64 and 66. However, steps 62 to 72 have to be carried out separately for different statistics. The process 60 for constructing the Impact Analysis Model ends at step 72.

In FIG. 3, step 68 can utilize any means necessary to determine the values of the parameters from the current configuration of the computer system. Values of some parameters may be determined by calls to the operating system running on the computer 10. Other parameter values may need to be sampled programmatically. Both step 66 and step 68 assume that the computer system can be instrumented to enable the embodiment of the present invention to collect values of parameters and measure values of statistics. Step 68 is also implicitly carried out in step 66 when deployment statistics are collected, as a set of parameters is collected prior to each deployment and is then associated with the statistic for that deployment.

Based on the assumptions in step 64 and the definitions of a parameter and a statistic above, each parameter has a relationship with the statistic. This relationship can be expressed mathematically as a function. In general, if there are n parameters that influence a statistic S, the statistic can be expressed as a function fₖ of each parameter Pₖ, 1≦k≦n, as follows:
S=fₖ(Pₖ)

FIG. 4 shows a possible graphical representation of the illustrated function fₖ (80). In reality, it is not possible to obtain the exact form of the function that will accurately represent the relationship between a parameter and a statistic in the context of the present invention. It is, however, possible to obtain parameter-statistic pairs by performing the data collection step 66. That is, actual values of the statistic can be collected that correspond to various values of the parameter. These parameter-statistic pairs are assumed to lie on the true function representing the -relationship between the parameter (Pₖ) and statistic (S). In FIG. 4, the collected parameter-statistic pairs are represented by the points (a, Sₐ) 84 and (c, S_{c}) 88. In accordance with the present invention, the value of the statistic is to be predicted using the values of the parameters that influence the statistic and that are sampled in step 68. Since the exact relationship between each parameter and the statistic is not known, the value of the statistic based on each parameter can be approximated. Suppose, the current configuration of the computer system in which a software application is to be deployed has a value for the k^{th} parameter of Pₖ=b. If the true function S=fₖ(Pₖ) was known, the value S_{b} 92 of the statistic of interest could simply be calculated using S_{b}=fₖ(b). However, the function of the statistic in terms of Pₖ is not known, all that is known from previously collected data is that the points (a, Sₐ) 84 and (c, S_{c}) 88 lie on the true function. Thus, a straight line 86 passing through the points (a, Sₐ) 84 and (c, S_{c}) 88 can approximate the true function. The equation of this straight line 86 using co-ordinate geometry is:

$$S = {S}_{a} + \frac{( {S}_{c} - {S}_{a} )}{( c - a )} ( {P}_{k} - a ) \qquad equation I$$

The approximate value of the statistic based on the value of the parameter Pₖ=b can now be obtained by substituting the value of the parameter into equation I above for the straight line 86, which is an approximation of the true function 82 representing the relationship between the parameter Pₖ and the statistic S, The approximate value of the statistic is S_{b} 90 in FIG. 4, and using equation I is given by

$${S}_{b}^{′} = {S}_{a} + \frac{( {S}_{c} - {S}_{a} )}{( c - a )} ( b - a ) \qquad Equation ( II )$$

The linear approximation described above can be easily applied to predicting statistics based on one parameter, as was shown. However, the problem becomes more complex when a statistic has to be predicted based on two or more parameters. This problem is solved in this embodiment of the present invention by the method for predicting statistics used in step 70 (FIG. 3). The method will now be described with reference to FIG. 6.

The inputs to the process 120 in FIG. 6 are:

1. n parameter values determined in step 68 (FIG. 3)in process 60, where n is an integer, n≧2.

2. A sufficient set of data is collected in step 66 in process 60. For this method of predicting the statistic, data needs to be collected for at least 2 values of each parameter. If data is to be collected for m₁ different values of parameter P₁, m₂ different values of parameter P₂ . . . , mₙ different values of parameter Pₙ, then the number of statistics that need to be collected in step 66 is m₁xm₂x . . . xmₙ, one for each of the different combinations of parameter values. The output of the process 120 (FIG. 6) is a predicted value of the statistic.

In FIG. 6, after beginning at step 122, an n+1 level binary tree of objects is constructed in step 124 according to the following rules. (Note that the top level is 1 and the bottom level is (n+1).)
a. The root node object is called a Line object. The leaf node objects are called BoundaryValue objects. The other node objects in the tree are called LineBoundaryValue objects,
b. Each node in the k^{th} level (except k=n+1) contains the value of the k^{th} parameter obtained in step 68.
c. Each node in the k^{th} level (except k=1) also contains a boundary value, being a value of the (k−1)^{th} parameter (that is, the parameter value of which is held, in the parent node) for which data was collected in step 66.
d. All left child nodes in the tree contain the lower boundary value for the parameter in the parent node. All right child nodes contain the upper boundary values of the parameter in the parent node.
e. Each node in the k^{th} level contains a statistic value corresponding to the set of boundary values of parameters represented by nodes on the path from that node to the root node of the tree. Thus, the values of the statistics in the (n+1)^{th} level correspond to combinations of values of all n parameters, and are obtained from the data collected in step 66.

The process 120 then moves to the nth level in step 126, which is the second from the last level in the tree. In step 128, for each node in the level, the value of the parameter in the node (according to paragraph (b) above), the boundary values in the two child nodes (according to paragraph (c) and paragraph (d) above) and the values of the statistic in the two child nodes (according to paragraph (e) above) together with the linear approximation equation II are used to find a statistic for that node. The value of the parameter is substituted into equation II for b, the boundary values in the left and right child nodes are substituted for a and c respectively, and the values of the statistic in the left and right child nodes are substituted for Sₐ and S_{c} respectively in FIG. 4. Thus, an approximation of the statistic value, S_{b} is obtained for each node in the current level in step 128.

If the current level in step 128 is level 1, as decided at step 130, the process 120 ends at step 134. Otherwise, the process moves to the next level up in step 132, and steps 126, 130 and 132 are repeated until level 1 of the tree is reached, at which stage the process 120 ends at step 134. As a result of the process 120, a statistic value is obtained in the Line object node of the tree (the root node), which is an estimate of the statistic for the set of parameter values obtained in step 68 of process 60 (FIG. 3) prior to performing the deployment.

The process 120 depicted in FIG. 6 will now be further explained using an example and FIG. 5. The example will solve the problem of predicting the time required statistic for a deployment based on two parameters, the size of the application to be deployed, param1, and the amount of RAM available in the system, param2. The necessary inputs to the process 120 are:
1. The two parameter values are determined in step 68 of process 60. For this example, suppose that the size of the application is determined prior to deployment to be 2 megabytes (MB), and the amount of RAM available is 100 MB. Thus, param1=2, and param2=100.

2. A sufficient set of data is collected in step 66 in FIG. 4. Since there are two parameters in this example, a sufficient data set would consist of two sample values for each parameter, that is 2×2=4 statistics collected in step 66. Suppose the statistics for various combinations of sampled parameter values are as given in Table I. The CombinationID column in Table I contains a unique identifier for each combination of parameters and their associated statistic:

TABLE I
Sampled data for the relationship between the parameters param1 and
param2 and the time required statistic, as collected in step 66.

| | Param1 | Param2 | Statistic |
|---|---|---|---|
| Combination | (Size of application) | (RAM) | (Time to |
| ID | (2 MB) | (2 MB) | deploy) |
| 001 | 1 | 50 | 100 |
| 002 | 1 | 150 | 60 |
| 003 | 3 | 50 | 150 |
| 004 | 3 | 150 | 120 |

The process 120 begins at step 122. In accordance with step 124, the object tree 100 constructed to represent the input data is shown in FIG. 5. The two parameters, param1=2 and param2=100, for which the statistic (time taken) is to be predicted are stored in the Line and LineBoundaryValue objects respectively. For each object storing a parameter, the two child objects hold the boundary values (values of the parameter for which statistics were measured in step 65). For example, the Line object 102 holds the first parameter (param1) with the value 2 for which the statistic is to be estimated. The two children, LineBoundaryValue objects 104 and 106, hold the boundary values boundary)=1 and boundary2=3 respectively for param1, since statistics were measured for param1 values of 1 and. 3 (as given in the second column of Table 1). Similarly, the LineBoundaryValue objects 104 and 106 each hold the value of the second parameter param2=100. The two left child objects, the BoundaryValue objects 108 and 112, hold the lower boundary value of 50 for param2 (from the third column of Table I). The two right child objects, the BoundaryValue objects 110 and 114, hold the upper boundary value of 150 for param2.

As a result of constructing the object tree 100 as described, looking down any branch of the tree 100, the combination of the boundary values held by the objects in the branch is a combination for which a statistic was measured. For instance, looking down the branch formed by objects 102, 106 and 112 the boundary values held in the branch are boundary2=3 (in object 106) and boundary3=50 (in object 112). In Table I it can be seen that this is the combination of parameters with CombinationID=003, and the statistic value collected for this set of parameter values and is equal to 150 (left child object). This value of the statistic can be found in the object tree 100 in BoundaryValue3 112 where statistic3=150. After constructing the object tree 100, step 126 in process 120 (FIG. 6) is carried out and level 2 is chosen as the current level since there are two parameters. To perform step 128, the LineBoundaryValue objects 104 and 106 in level 2 of the tree 100 are considered in turn. To compute statistic1 (as shown in FIG. 5) in LineBoundaryValue1 104 (as shown in FIG. 5), the values contained in objects 104, 108 and 110 are substituted into equation II as follows:
b=param2 in 104=100
a=boundary1 in 108=50
c=boundary2 in 110=150
Sₐ=statistic1 in 108=100
S_{c}=statistic2 in 110=60
S^{b}=statistic in 104=?

Thus, statistic1 in the LineBoundaryValue1 object 104 is given by

$$statistic1 = {S}_{a} + \frac{( {S}_{c} - {S}_{a} )}{( c - a )} ( b - a ) = 100 + \frac{( 60 - 100 )}{( 150 - 50 )} ( 100 - 50 ) = 80$$

To compute statistic2 in Line BoundaryValue2 106, the values contained in objects 106, 112 and 114 are substituted into equation II as follows:
b=param2 in 106=100
a=boundary3 in 112=50
c=boundary4 in 114=150
Sₐ=statistic3 in 112=150
S_{c}=statistic4 in 114=120
S_{b′}=statistic2 in 106=?
Thus, statistic2 in the LineBoundaryValue2 object 106 is given by

$$statistic2 = {S}_{a} + \frac{( {S}_{c} - {S}_{a} )}{( c - a )} ( b - a ) = 150 + \frac{( 120 - 150 )}{( 150 - 50 )} ( 100 - 50 ) = 135$$

The above two computations constitute step 128 for object tree 100 and the process 120 moves to step 130. Since the current level is 2, which does not equal to 1, process 120 moves to step 132, the current level becomes level 1, and process 120 loops to step 128. According to step 128, the statistic for each object in level 1 is to be found. Since the Lineal object 102 (FIG. 5) is the only object in level 1 of the tree 100, finding its statistic would constitute step 128. Once again, to compute the statistic in Line1 102, the values contained in objects 102, 104 and 106 are substituted into equation II as follows:
b=param1 in 102=2
a=boundary1 in 104=1
c=boundary2 in 106=3
Sₐ=statistic1 in 104=80 (computed above)
S_{c}=statistic2 in 106=135 (computed above)
S^{b}=statistic in 102=?
Thus, statistic in the Line 1 object 102 is given by

$$statistic = {S}_{a} + \frac{( {S}_{c} - {S}_{a} )}{( c - a )} ( b - a ) = 80 + \frac{( 135 - 80 )}{( 3 - 1 )} ( 2 - 1 ) = 107.5$$

The above calculation concludes step 128 in process 120, and process 120 moves to step 130. Since the current level is level 1, process 120 ends in step 134. The predicted value of the statistic is now in the Lin1 object 102 and is equal to 107.5 seconds.

The process 120 can be applied to predicting any statistic, not just time, based on any number of parameters, not just two parameters, as described in the example above. Furthermore, the process 120 is only one possible method of implementing step 70 of process 60 in FIG. 3, and the present invention is not limited to this implementation of step 70.

The present invention also relates to the method for improving the accuracy of the predicted statistic by updating the Impact Analysis model 60 to include actual statistics collected as more and more deployments are performed. This method 140 is depicted in FIG. 7. Beginning at step 142, the resource usage for a deployment is predicted in step 144 by carrying out the steps of the model 60. In step 146, the deployment for which resource usage has been predicted is carried out, and the actual resource usage during the deployment is measured and stored in step 148.

In step 150, the model 60 is updated to incorporate the statistic from step 148 by combining the actual statistic with the data previously collected and stored in step 66 of the model 60. This embodiment of the present invention does not propose a method for performing step 150. The method for updating the model 60 ends at step 152.

As stated previously, the present invention is concerned with the prediction of statistics. This embodiment of the present invention uses linear approximation to estimate a statistic, and this estimate is thus subject to the linear approximation error. This embodiment of the present invention does not include a method for determining this error.

It should be noted that the methods used to implement this embodiment of the present invention could be modified without departing from the scope of the invention.

Therefore, this embodiment of the present invention should be considered illustrative and not restrictive.

1. A method for estimating a quantity of a resource required during installation of a software application on a computing system, comprising the steps of accessing a database containing historical resource utilisation data for installation of the software application on other computing systems, selecting a value for a parameter of the computing system relevant to resource utilisation and a value for a parameter of the software application relevant to resource utilisation and using the historical resource utilisation data and the selected parameter values to estimate the quantity of the resource required for installation of the software application.

2. A method in accordance with claim 1, wherein the historical resource utilisation data includes parameter values of the computing systems and parameter values of the software applications historically installed.

3. A method in accordance with claim 2, wherein the historical resource utilisation data includes statistics, the statistics being values of the quantities of resources used in the historical installation.

4. A method in accordance with claim 3, wherein the historical resource utilisation data includes at least two parameter/statistic pairs for historical installation.

5. A method in accordance with claim 3, wherein the relationship between the parameter and statistic pairs is derived by applying a statistical model to the parameter/statistic pairs.

6. A method in accordance with claim 4, wherein a relationship is predicted between a statistic and n distinct parameters, where n is any integer greater than or equal to two, comprising the further step of obtaining mₙ different values for each parameter Pₙ, and further obtaining at least m₁m₂ mₙ values of a statistic for each distinct combination of parameter values, where m₁m₂ mₙ represents the product of values m₁, m₂, . . . mₙ.

7. A method in accordance with claim 5, wherein the relationship between the statistic and the parameter or n parameters is determined by assuming that the relationship between the parameter/statistic pairs takes the form of a straight line.

8. A method in accordance with claim 6, wherein the equation of the straight line is calculated using co-ordinate geometry.

9. A method in accordance with claim 7, wherein the mathematical model takes the form:
$$S = {S}_{a} + \frac{( {S}_{c} - {S}_{a} )}{( c - a )} ( {P}_{k} - a )$$

10. A computing system arranged to facilitate the prediction of a statistic for use in the estimation of resources required during installation of a software application, comprising, a database including historical resource utilisation data of the resources required during installation of software applications on computing systems, means for selecting a value for a parameter of the computing system relevant to resource utilisation, and a value for a parameter of the software application relevant to resource utilisation, and computation means arranged to utilise the historical resource utilisation data and parameter values to estimate the quantity of the resource required for installation of the software application.

11. A system in accordance with claim 10, wherein the historical resource utilisation data includes parameter values of the computing systems and parameter values of the software applications historically installed.

12. A system in accordance with claim 11, wherein the historical resource utilisation data includes statistics, the statistics being values of the quantities of resources used in the historical installation.

13. A system in accordance with claim 12, wherein the historical resource utilisation data includes at least two parameter/statistic pairs for historical installation.

14. A system in accordance with claim 13, wherein the relationship between the parameter and statistic pairs is derived by applying a statistical model to the parameter/statistic pairs.

15. A system in accordance with claim 14, wherein a relationship is predicted between a statistic and n distinct parameters, where n is any integer greater than or equal to two, comprising the further step of obtaining mₙ different values for each parameter Pₙ, and further obtaining at least m₁m₂ mₙ values of a statistic for each distinct combination of parameter values, where m₁m₂ mₙ represents the product of values m₁, m₂, . . . mₙ.

16. A system in accordance with claim 15, wherein the relationship between the statistic and the parameter or n parameters is determined by assuming that the relationship between the parameter/statistic pairs takes the form of a straight line.

17. A system in accordance with claim 16, wherein the equation of the straight line is calculated using co-ordinate geometry.

18. A system in accordance with claim 17, wherein the mathematical model takes the form:
$$S = {S}_{a} + \frac{( {S}_{c} - {S}_{a} )}{( c - a )} ( {P}_{k} - a )$$

19. A computer program arranged, when loaded on a computing system, to implement the method of any one of claims 1 to 9.

20. A computer readable medium providing a computer program in accordance with claim 19.

21. A method for building a model for use in the prediction of resources required for the installation of a software application, the method comprising the steps of collecting historical resource utilisation data of resources utilised during the installation of software applications on computing systems, and storing the historical resource usage data.

22. A model comprising historical resource utilisation data of resources utilised during the installation of software applications on computing systems, the data being stored in a database.
